(19) United States
(12) Patent Application Publication
(10) Pub. No.: US 2021/0091517 A1
(43) Pub. Date: Mar. 25, 2021

(54) COAXIAL CONNECTOR DEVICE

(71) Applicant: Canare Electric Co., Ltd., Aichi (JP)

(72) Inventors: Motoki OGASAWARA, Yokohama-Shi (JP); Hiroshi ZUSHI, Yokohama-Shi (JP)

(73) Assignee: Canare Electric Co., Ltd.

(21) Appl. No.: 17/025,032

(22) Filed: Sep. 18, 2020

(30) Foreign Application Priority Data
Sep. 20, 2019 (JP) 2019-171179

(51) Int. Cl. H01R 24/50; H01R 12/75

(52) U.S. Cl. CPC H01R 24/50; H01R 2103/00; H01R 12/75

(57) ABSTRACT

A coaxial connector device includes a main connector and a board connector. A main connector body has a first fitting part for a coaxial cable connector at one end, and a second fitting part at the other end. The main connector body includes, in its inside, a center contact and a card edge substrate. In a board connector body, a slot is formed and, and a conductive plate member is positioned on the side opposite to the side where the slot is formed such that the conductive plate member is not in contact with inner contacts of the board connector body. When the second fitting part is fitted to the board connector, an end portion of the card edge substrate is coupled to the slot, substrate contacts included in the card edge substrate electrically contact the inner contacts, and the second fitting part electrically contacts an outer conductor contact.

### TECHNICAL FIELD

The present invention relates to a coaxial connector device, and more particularly to a coaxial connector device used for electrically connecting a coaxial cable attached with a connector and a printed circuit board.

### BACKGROUND

Various coaxial connectors for electrically connecting a coaxial cable attached with a connector and a printed circuit board are already known (see, for example, Japanese Unexamined Patent Application Publication Nos. 2003-151693 and 2012-54030). In fixing a coaxial connector to an apparatus, terminals (such as connecting parts and terminal pins) of the coaxial connector are inserted into holes formed in a printed circuit board inside the apparatus, and as such the coaxial connector is electrically connected to a circuit formed on the printed circuit board.

For example, in a coaxial connector disclosed in Japanese Unexamined Patent Application Publication No. 2003-151693, a connecting part of an inner conductor and a connecting part of an outer conductor are inserted into holes formed in a printed circuit board inside an apparatus and soldered. Similarly, in an active connector (see FIG. 9) disclosed in Japanese Unexamined Patent Application Publication No. 2012-54030, one end of each of terminal pins 85 and ground lug pins 87a of ground lugs 87 are inserted into holes formed in a printed circuit board inside an apparatus and soldered. The other end of each of the terminal pins 85 is inserted into a hole formed in an internal printed circuit board 83 in the connector base 81 and soldered.

Currently, various broadcasting equipment that conforms to 4K/8K broadcasting is being developed, and some broadcasting apparatuses have already been in practical use. As interface standards for connecting such broadcasting apparatuses each other, 3G-SDI (Serial Digital Interface) having a transmission rate of 3 gigabits per second (Gb/s) and 12G-SDI having a transmission rate of 12 Gb/s have been standardized. In these interface standards, high electrical performance and reliability are require for wiring systems of equipment. Therefore, a connector for connecting a transmission line (a coaxial cable) and an apparatus is desired such that the connector is designed and mounted to minimize deterioration in signal quality and signal characteristics.

In the coaxial connector disclosed in Japanese Unexamined Patent Application Publication No. 2003-151693, when the connecting parts of an inner conductor are inserted into holes formed in a printed circuit board inside an apparatus, the tips of the connecting parts protrude from the back surface of the printed circuit board to form stubs. Similarly, in the active connector, shown in FIG. 9, disclosed in Japanese Unexamined Patent Application Publication No. 2012-54030, too, when a plurality of terminal pins 85 are inserted into the holes formed in a printed circuit board inside an apparatus, the tips of the terminal pins protrude from the back surface of the printed circuit board to form stubs.

Stubs protruding from the front/back surface of a printed circuit board are called via stubs or dangling via stubs. These stubs cause deterioration of signal quality and transmission characteristics at a radio frequency or at a higher frequency. Therefore, for connectors that conform to standards for extremely high-speed signal transmission such as 12G-SDI, solving the stub problem described above is desired.

Also, when connecting the previously existing connector to the printed circuit board, the connecting parts of the inner and outer conductors, the terminal pins and the ground lug pins are manually soldered from the back surface of the printed circuit board. Therefore, there is room for improvement of connection work efficiency. There is also a problem that, when the connector has to be detached after the connector is once mounted, it takes time and effort to detach the connector.

The present applicant has proposed a coaxial connector device that can solve the above problems (Japanese Patent No. 6498373). The coaxial connector device includes a main connector and a board connector to be mounted on a printed circuit board. The main connector includes a center contact positioned, inside a main connector body, on a side with a first fitting part and a card edge substrate positioned, inside the main connector body, on a side with a second fitting part and electrically connected to the center contact. On the other hand, the board connector to be fitted to the second fitting part of the main connector includes a board connector body in which a slot is formed, the board connector body being provided with a plurality of contacts in the slot, and an outer conductor contact provided in the board connector body. When the second fitting part of the main connector is fitted to the board connector, an end portion of the card edge substrate is coupled to the slot in the board connector body, a plurality of substrate contacts included in the card edge substrate electrically contact the plurality of contacts of the board connector body, and the second fitting part of the main connector electrically contacts the outer conductor contact.

The coaxial connector device disclosed in Japanese Patent No. 6498373 can be mounted on a printed circuit board so as not to form any stub, and has an advantage that deterioration of signal quality and transmission characteristics at high frequencies can be reduced. In addition, the coaxial connector device makes it possible to fit the main connector to the board connector after the board connector is mounted on the surface of the printed circuit board. This is advantageous in that efficiency of connecting the coaxial connector device to a printed circuit board can be improved.

### SUMMARY OF THE INVENTION

The coaxial connector device proposed by the applicant as stated above includes, according to an example of the embodiment, a right angle coaxial connector device, which is configured to allow a main connector to be plugged in and unplugged from a printed circuit board horizontally with respect to one face of the printed circuit board. However, it has been found that, when the right angle coaxial connector device is mounted on a printed circuit board, some other problems related to signal transmission characteristics and radiation occur under certain conditions of use.

Hence, an object of the present invention is to provide a coaxial connector device that can solve problems related to signal transmission characteristics and radiation that occur under certain conditions of use.

The coaxial connector device of the present invention aimed at solving the above problems is for electrically connecting a coaxial cable connector and a printed circuit board, and includes a main connector and a board connector to be mounted on a printed circuit board. The main connector includes: a conductive main connector body having a first fitting part for a coaxial cable connector at one end, and a second fitting part at the other end, a center contact positioned, inside the main connector body, on a side with the first fitting part; and a card edge substrate positioned, inside the main connector body, on a side with the second fitting part, the card edge substrate being electrically connected to the center contact. The board connector includes: a board connector body in which a slot is formed, the board connector body being provided with a plurality of contacts in the slot; an outer conductor contact provided in the board connector body; and a conductive plate member. The conductive plate member is positioned on a side opposite to the side where the slot is formed in the board connector body such that the conductive plate member is not in contact with the plurality of contacts in the slot. When the second fitting part of the main connector body is fitted to the board connector, an end portion of the card edge substrate is coupled to the slot in the board connector body, a plurality of substrate contacts included in the card edge substrate electrically contact the contacts of the board connector body, and the second fitting part of the main connector body electrically contacts the outer conductor contact.

In a preferred embodiment of the coaxial connector device according to the present invention, when the board connector is mounted on the printed circuit board, the conductive plate member may be at ground potential.

Also, in a preferred embodiment of the coaxial connector device according to the present invention, the conductive plate member may be formed integrally with and as a part of the outer conductor contact.

Furthermore, in a preferred embodiment of the coaxial connector device according to the present invention, the second fitting part may have an inner face which, when the second fitting part is fitted to the board connector, contacts at least the outer conductor contact.

Also, in a preferred embodiment of the coaxial connector device according to the present invention, the inner face of the second fitting part of the main connector may be cylindrical or semi-cylindrical and the outer conductor contact of the board connector may include a spring member provided outside the board connector body.

Furthermore, in a preferred embodiment of the coaxial connector device according to the present invention, each of the plurality of contacts of the board connector and the outer conductor contact may have a connection terminal extending from a bottom part or a bottom face of the board connector body in the width direction of the board connector.

Also, in a preferred embodiment of the coaxial connector device according to the present invention, the connection terminals of the board connector may be configured such that, when the board connector is mounted on a surface of a printed circuit board, the connection terminals are connected to respective wirings on the printed circuit board.

Furthermore, in a preferred embodiment of the coaxial connector device according to the present invention, the card edge substrate of the main connector may include at least one active circuit.

Additionally, in a preferred embodiment of the coaxial connector device according to the present invention, the active circuit may include at least a first matching circuit, a second matching circuit to be connected to the center contact, and a buffer circuit provided between the first matching circuit and the second matching circuit.

Also, in a preferred embodiment of the coaxial connector device according to the present invention, the slot in the board connector may be formed such that, when the board connector is mounted on a printed circuit board, the slot is oriented at a predetermined angle with respect to one face of the printed circuit board or in parallel with the one face of the printed circuit board.

The board connector of the coaxial connector device according to the present invention includes a conductive plate member positioned on a side opposite to the side where a slot is formed in the board connector body such that the conductive plate member is not in contact with a plurality of contacts. This solves the problems related to signal transmission characteristics and radiation which occur under certain conditions of use.

The objects and advantages of the present invention described above and other objects and advantages will be understood more clearly through the following description of embodiment. However, the embodiment being described in the following is an example for illustrative purposes, and the present invention is not limited to the embodiment.

### BRIEF DESCRIPTION OF THE DRAWINGS

FIG. 1 is a perspective view of an example of a coaxial connector device without the present invention applied to.

FIG. 2 is a perspective view of an example of aboard connector included in the coaxial connector device without the present invention applied to.

FIG. 3 is a perspective sectional view of the coaxial connector device without the present invention applied to.

FIGS. 4A and 4B are block diagrams each showing an example of an active circuit mounted on a card edge substrate included in a main connector.

FIGS. 5A and 5B each show an example of a board connector included in a coaxial connector device with the present invention applied to, FIG. 5A being a perspective view and FIG. 5B being a plan view.

FIGS. 6A and 6B each show an example of a board connector included in the coaxial connector device with the present invention applied to, FIG. 6Abeing a right side view and FIG. 6B being a right-side longitudinal sectional view.

FIG. 7 is a perspective view of the coaxial connector device with the present invention applied to.

FIG. 8 is a perspective view of the coaxial connector device with the present invention applied to.

FIG. 9 is a perspective view showing a configuration example of an existing active connector.

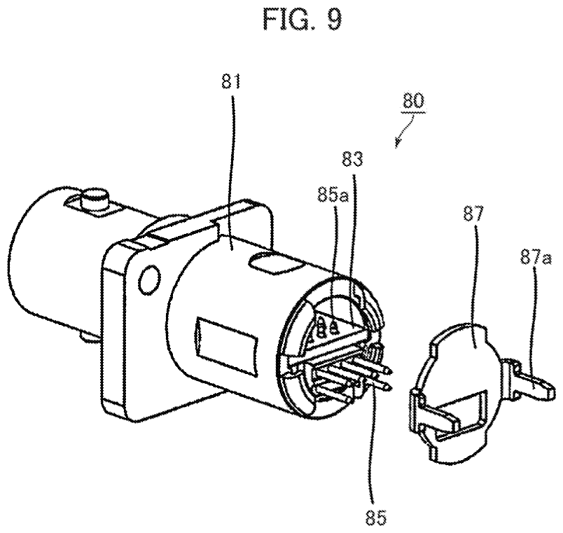

### DETAILED DESCRIPTION

In the following, preferred embodiments of a coaxial connector device according to the present invention will be described in detail with reference to drawings. First, a coaxial connector device without the present invention applied to will be described, then an example of an improved coaxial connector device with the present invention applied to will be described in detail.

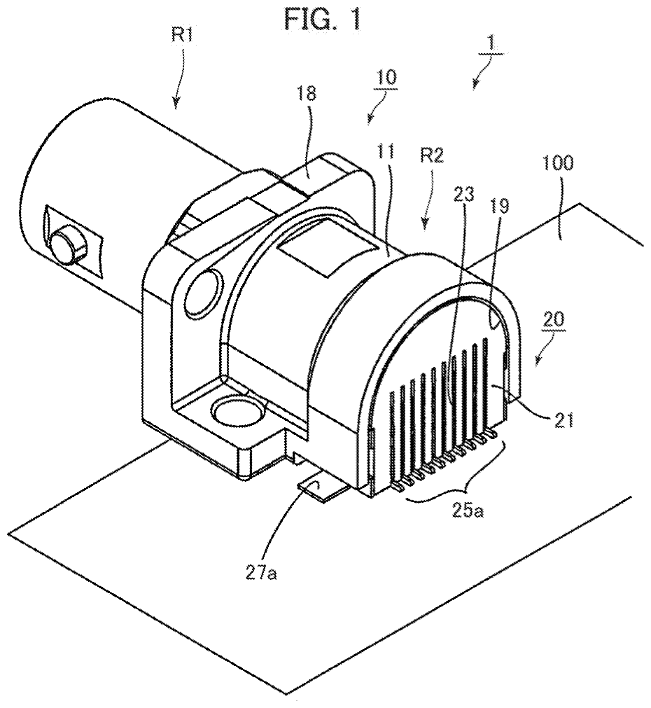

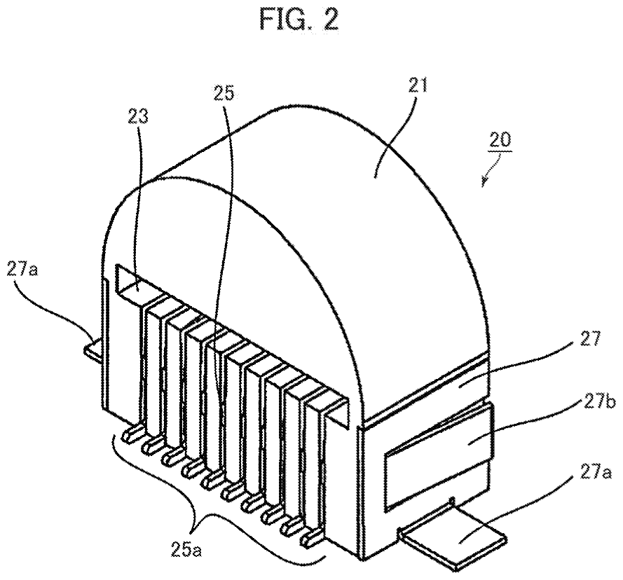

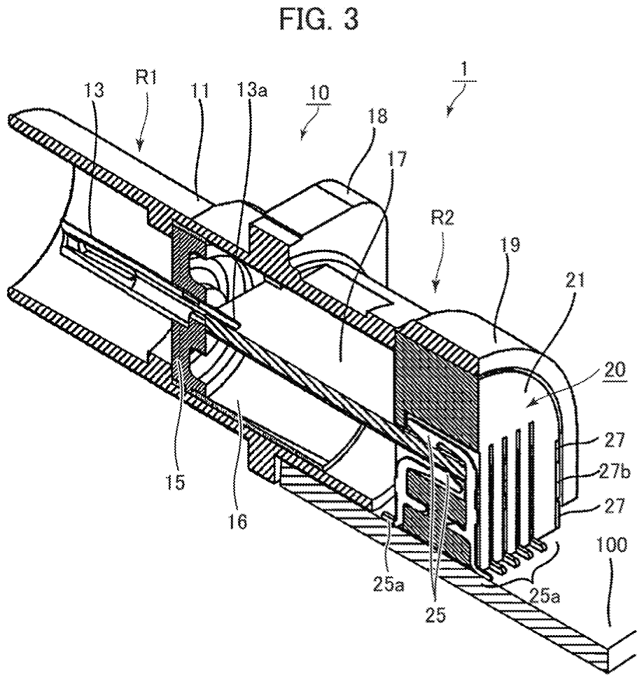

FIG. 1 is a perspective view of an example of a coaxial connector device without the present invention applied to. FIG. 2 is a perspective view of an example of a board connector suitably used for the coaxial connector device. FIG. 3 is a perspective sectional view of the coaxial connector device mounted on a printed circuit board.

The coaxial connector device of the present embodiment being described in the following is an example of a right angle coaxial connector device configured as follows: a Bayonet Neil-Concelman (BNC) connector plug is fitted to one end of a main connector; a board connector is fitted to the other end of the main connector; the board connector is mounted on a printed circuit board; and the BNC connector plug and the main connector can be plugged in and unplugged from the printed circuit board in a horizontal direction with respect to one face of the printed circuit board. This coaxial connector device is a mere example, and the present invention is not limited to the example.

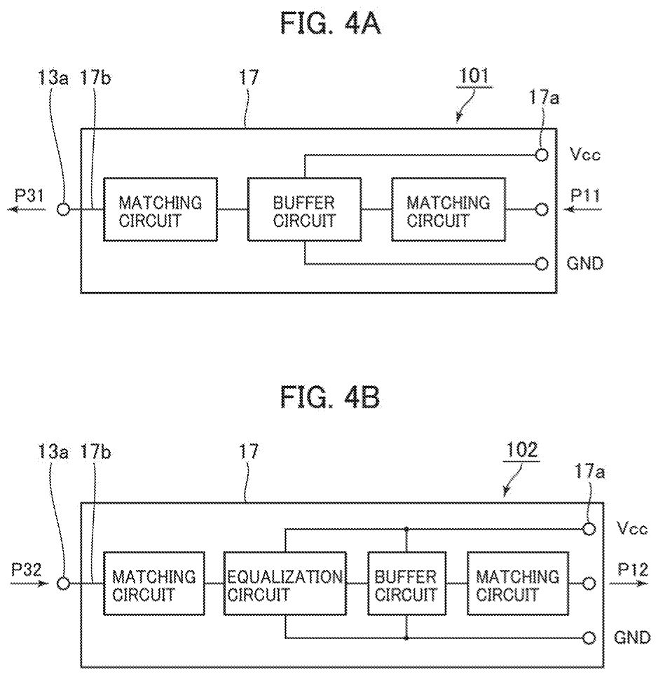

Referring to FIGS. 1 to 3, a coaxial connector device 1 of a right angle type includes a main connector 10 and a board connector 20. The main connector 10 includes a conductive main connector body 11, a center contact 13, and a card edge substrate 17. The main connector body has a fitting part R1 (corresponding to a first fitting part) for a BNC connector plug at one end, and a fitting part R2 (corresponding to a second fitting part) at the other end. The center contact 13 is positioned, inside the main connector body 11, on a side with the plug fitting part R1. The card edge substrate 17 is positioned, inside the main connector body 11, on a side with the second fitting part R2, and is electrically connected to the center contact 13. The card edge substrate 17 is electrically connected to the center contact 13, and a plurality of substrate contacts 17a (see FIGS. 4A and 4B) are formed on at least one face or on both faces thereof. A fitting end 19 of the second fitting part R2 has a semi-cylindrical inner face that is to contact with the face of an outer conductor contact 27 of a board connector 20, which will be described later. Further, a fixing part 18 of the main connector body 11 is provided, when attaching the coaxial connector device 1 to an apparatus like broadcasting equipment (not shown), for example, so as to fix the fixing part 18 to a cabling panel (not shown) of the apparatus and a printed circuit board 100 with screws.

Referring to FIG. 3, the center contact 13 is supported and electrically insulated, from the main connector body 11 of the main connector 10, by an insulating member 15. The center contact 13 has a female contact part at one end (on the first fitting part R1 side) and a connecting part 13a for connection with a card edge substrate 17 at the other end. The center contact 13 contacts the card edge substrate 17, and then the connecting part 13a is electrically connected to the card edge substrate 17.

Preferably, at least one wiring 17b (see FIGS. 4A and 4B) that electrically connects the connecting part 13a of the center contact 13 and the substrate contacts 17a is provided on at least one face or on both faces of the card edge substrate 17. At least one active circuit may be provided in a midway portion of the wiring 17b on the card edge substrate 17. Namely, the main connector 10 may be additionally provided with a function as an active connector by implementing one or more active circuits on the card edge substrate 17.

FIGS. 4A and 4B are block diagrams each showing an example of an active circuit implemented on the card edge substrate 17. The active circuits shown in FIGS. 4A and 4B are mere examples, and the active circuits that can be implemented on the card edge substrate 17 are not limited to the examples. Referring to the block diagram shown in FIG. 4A, the wiring 17b on the card edge substrate 17 includes, in a midway portion thereof, includes an active circuit 101 including a first matching circuit positioned on the substrate contacts 17a side, a second matching circuit positioned on the side with connecting part 13a of the center contact 13, and a buffer circuit positioned between the first and second matching circuits. In the present example, the substrate contacts 17a to which the wiring 17b is connected include a supply terminal for direct-current (DC) voltage Vcc, an input terminal for input signal P11, and a GND terminal. To the connecting part 13a of the center contact 13 to which the wiring 17b is connected, an output signal P31 is supplied. The buffer circuit is driven by DC voltage Vcc supplied from the apparatus side. The buffer circuit has a function of preventing mutual influence between the input signal P11 and the output signal P31. The main connector 10 including the card edge substrate 17 on which the active circuit 101 as shown in FIG. 4A is implemented is suitable as an active connector for application to an apparatus on the transmission side.

Referring to the block diagram shown in FIG. 4B, the wiring 17b on the card edge substrate 17 includes, in a midway portion thereof, includes an active circuit 102 including a first matching circuit positioned on the substrate contacts 17a side, a second matching circuit positioned on the side with the connecting part 13a of the center contact 13, an equalization circuit, and a buffer circuit both positioned between the first and second matching circuits. In the present example, the substrate contacts 17a to which the wiring 17b is connected include a supply terminal for DC voltage Vcc, an output terminal for output signal P12, and a GND terminal. From the wiring 17b connected to the contacting part 13a of the center contact 13, an input signal P32 is supplied. The buffer circuit is driven by DC voltage Vcc supplied from the apparatus side. The buffer circuit has a function of preventing mutual influence between the output signal P12 and the input signal P32. The equalization circuit has a function of correcting frequency characteristics of and/or loss in the coaxial cable used as a transmission line. The equalization circuit is also driven by DC voltage Vcc supplied from the apparatus side. The main connector 10 including the card edge substrate 17 on which the active circuit 102 as shown in FIG. 4B is implemented is suitable as an active connector for application to an apparatus on the receiving side.

Referring to FIG. 3 again, the card edge substrate 17 is mechanically supported and fixed inside the second fitting part R2 by a support member 16 provided on the side of the second fitting part R2 of the main connector body 11 of the main connector 10. The support member 16 may be formed of a conductive material having a desired mechanical strength so that an end portion of the card edge substrate 17 can be stably plugged in and unplugged from a slot 23 (as will be described later with reference to FIG. 1) of the board connector 20.

Referring to FIGS. 1 to 3, the board connector 20 includes a board connector body 21 and an outer conductor contact 27. The board connector body 21 includes the slot 23 formed therein with a plurality of inner contacts 25 provided inside the slot 23. The board connector body 21 of the board connector 20 has a short semi-cylindrical outer shape (an inverted-U shape), and the slot 23 is formed such that, when the board connector 20 is mounted on the printed circuit board 100, the slot 23 is oriented in parallel with one face of the printed circuit board 100. The outer conductor contact 27 is fixedly provided outside the board connector body 21. The outer conductor contact 27 may include conductive spring members. Each of the inner contacts 25 included in the board connector body 21 and the outer conductor contact 27 have connection terminals 25a and 27a extending from a bottom part or from the bottom face of the board connector body 21 in the width direction of the board connector 21.

Referring to FIGS. 1 and 3, the board connector 20 configured as described above can be mounted on one face of the printed circuit board 100. The connection terminals 25a and 27a of the board connector 20 can be configured such that, when the board connector 20 is mounted on the surface of the printed circuit board 100, the terminals 25a and 27a are connected to respective wirings (not shown) formed on the printed circuit board 100. Therefore, the board connector 20 can be mounted on the printed circuit board 100 without causing stub formation. For this mounting work, reflow soldering can be used. Conventionally, manual soldering used to be involved, but the board connector 20 making manual soldering unnecessary can improve work efficiency.

In the coaxial connector device 1, the main connector 10 is configured to be detachable from the board connector 20. When the second fitting part R2 of the main connector 10 is fitted to the board connector 20, the end portion of the card edge substrate 17 is coupled to the slot 23 in the board connector body 21, the substrate contacts 17a of the card edge substrate 17 electrically contact the inner contacts 25 of the board connector body 21, and the second fitting part R2 of the main connector 21 electrically contacts the outer conductor contact 27. In cases where the outer conductor contact 27 includes conductive spring members (for example, spring portions 27b shown in FIGS. 2 and 3), when the face of the outer conductor contact 27 comes into contact with the semi-cylindrical inner face of the fitting end portion 19 of the second fitting part R2, the spring elasticity of the outer conductor contact 27 advantageously works to make electrical contact and mechanical coupling between them more stable.

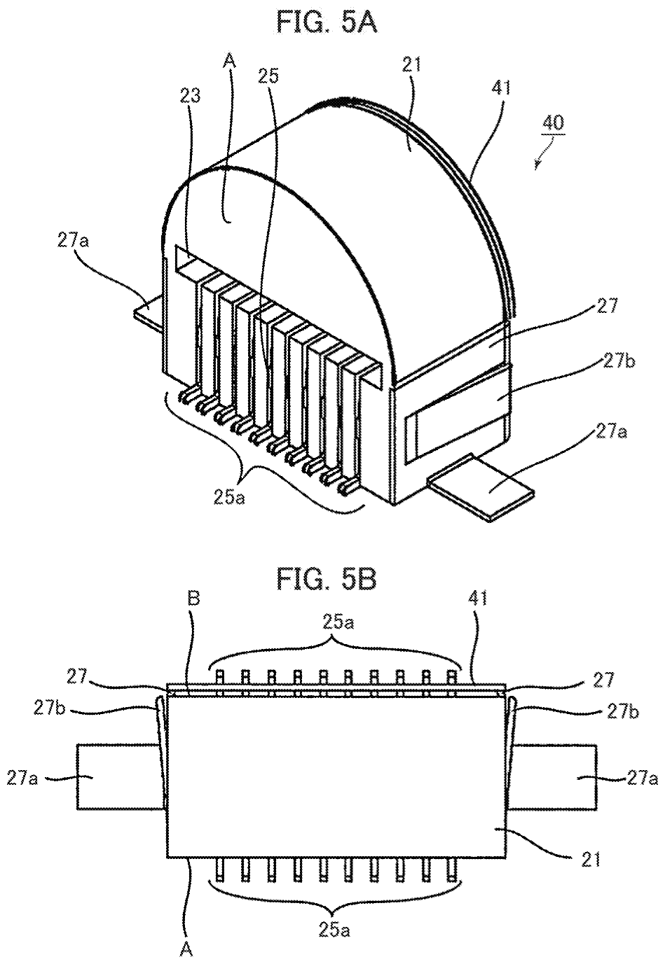

However, it has been found that mounting the above-described right angle coaxial connector device 1 on the printed circuit board 100 causes, under certain conditions of use, other problems related to signal transmission characteristics. Specifically, one of the problems is that there are cases in which, when a weak signal transmitted through a long coaxial cable exceeding a certain cable length is inputted to the coaxial connector device and is then outputted from the coaxial connector device, the signal is affected by external noise. Another problem is that there are cases in which, when a strong signal is inputted to the coaxial connector device, unwanted radiation occurs causing elements and other coaxial connector devices located near the coaxial connector device having received the strong signal to be affected by noise. Particularly, it has been found that there are cases in which, when a plurality of coaxial connector devices are arranged adjacently to one another, mutually adjacent coaxial connector devices are affected by crosstalk. As a result of making various modifications and conducting various tests, the present inventors have completed an improved coaxial connector device that can solve the above problems. In the following, an example of an improved coaxial connector device with the present invention applied to will be described in detail with reference to FIGS. 5A and 5B to FIG. 8.

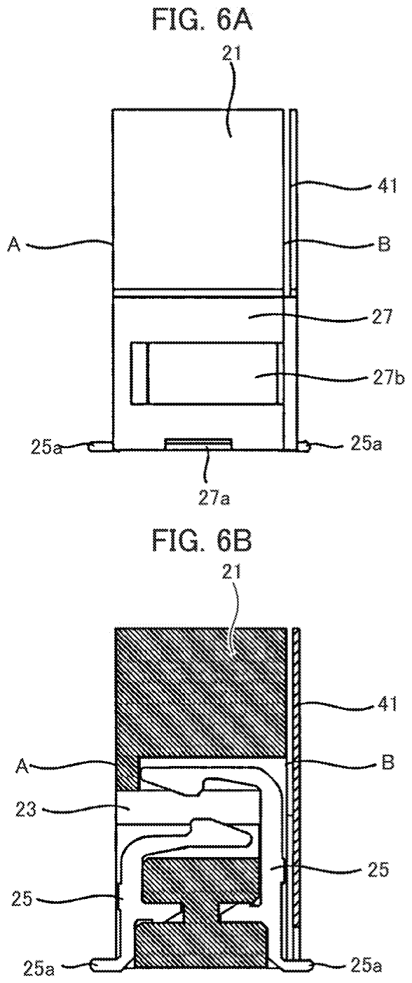

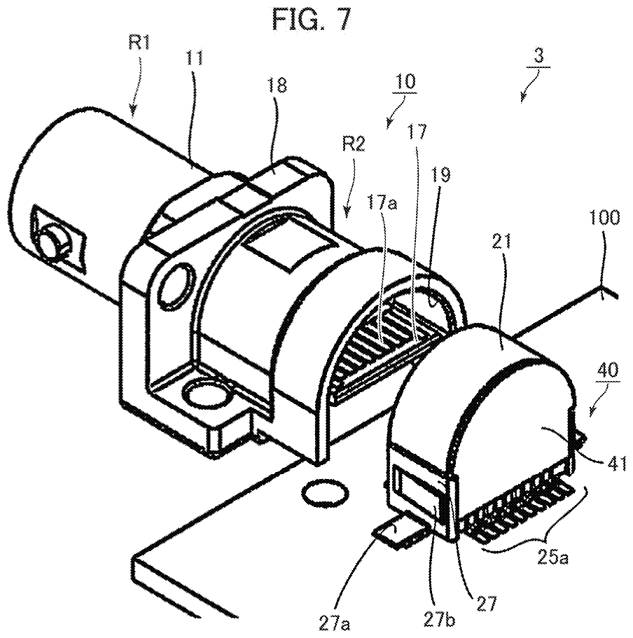

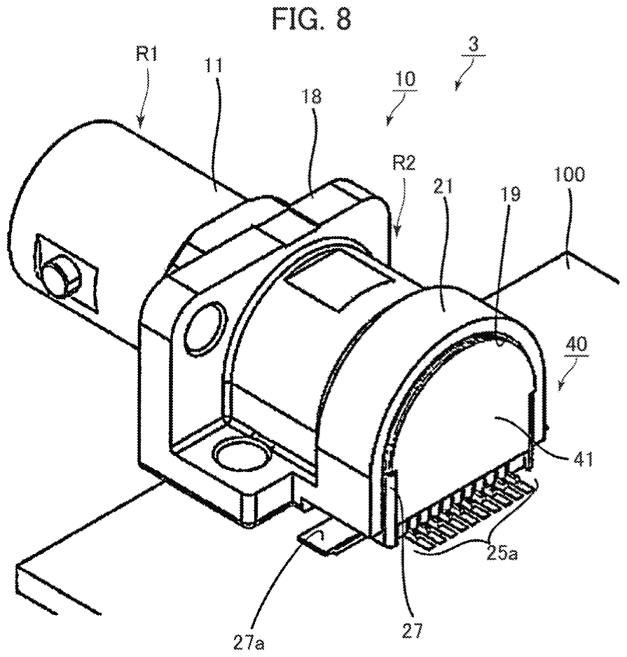

FIGS. 5A and 5B and FIGS. 6A and 6B illustrate an example of a board connector suitably used in an improved coaxial connector device with the present invention applied to. Here, FIG. 5A is a perspective view, FIG. 5B is a plan view, FIG. 6A is a right side view, and FIG. 6B is a right-side longitudinal sectional view of the board connector, respectively. Moreover, FIGS. 7 and 8 are perspective views of an example of the improved coaxial connector device with the present invention applied to. In these drawings, components identical to those used in the coaxial connector device shown in FIGS. 1 to 3 are denoted by the same reference numerals as those used in FIGS. 1 to 3.

Referring to FIGS. 7 and 8, the main connector 10 included in the coaxial connector device 3 is configured similarly to the coaxial connector device 1 shown in FIGS. 1 and 3. The improved coaxial connector device 3 differs from the coaxial connector device 1 in that a board connector 40 includes a conductive plate member 41.

Referring to FIGS. 5A and 5B to FIG. 8, the board connector 40 includes a conductive plate member 41. The conductive plate member 41 is positioned on side B opposite to side A where the slot 23 is formed in the board connector body 21 such that the conductive plate member 41 is not in contact with the inner contacts 25. When the board connector 40 is mounted on the printed circuit board 100, the conductive plate member 41 may be set to ground potential. Since the outer conductor contact 27 of the board connector 40 mounted on the printed circuit board 100 is normally held at ground potential, the conductive plate member 41 may be formed integrally with, as a part of, the outer conductor contact 27. Or, the conductive plate member 41 may be provided as a discrete member to be electrically and mechanically coupled to the outer conductor contact 27. The conductive plate member 41 integrated with the outer conductor contact 27 can be manufactured by punching a plate or sheet of conductive metal, for example, a copper alloy. Such an integrally formed component is advantageous because an increase in the number of components and assembly man-hours can be avoided.

The shape and size of the conductive plate member 41 may be appropriately designed based on the shape and size of the board connector body 21 on the opposite side B. However, the conductive plate member 41 preferably has a shape and size good for covering the slits and the inner contacts 25 respectively positioned inside the slits on the opposite side B of the board connector body 21. For example, the conductive plate member 41 may be formed, as shown in FIGS. 5A and 5B to FIG. 8, as an approximately semi-circular metal plate to cover the surface, excluding a lower portion, of the board connector body 21 on the opposite side B.

The present inventors assume the reasons why the coaxial connector device 3 including the main connector 10 and the board connector 40 that includes the conductive plate member 41 can solve problems of external noise, unwanted radiation and crosstalk as follows. The conductive plate member 41 positioned on side B opposite to side A where the slot 23 is formed in the board connector 40 serves as a shield to suppress the effect of external high-frequency waves against the inner contacts 25 included in the board connector 40 being, and outward radiation of the high-frequency waves from the inner contacts 25.

The present embodiment has been described based on the above examples, i.e., one in which the fitting end portion of the second fitting part included in the main connector body has a semi-cylindrical inner face and the other in which the board connector body has a short semi-columnar outer shape (an inverted-U shape), but the examples have been described for illustrative purposes only. The fitting end portion of the second fitting part may have a differently shaped inner face, and the board connector body may have a different outer shape. For example, the fitting end portion of the second fitting part may have a cylindrical inner face, and the board connector body may have a short cylindrical outer shape. Also, in describing the present embodiment, the main connector has been described mainly as functioning as an active connector including an active circuit in a midway portion of the card edge substrate wiring. However, the description of the main connector is for illustrative purposes only, and the main connector may be a so-called passive connector without any active circuit included in the card edge substrate wiring.

The coaxial connector device according to the present invention is specifically effective at input end or output end of various apparatus that transmit signals or electric power using a transmission line (broadcasting equipment, video and audio equipment, signal transmission terminals, signal receiving terminals, relay devices, and any other devices) when it is necessary to satisfy high-level requirements for the signal quality and transmission characteristics at high frequencies.

The present invention is widely applicable to coaxial connector devices for electrically connecting a coaxial cable attached with a connector and a printed circuit board.

What is claimed is:

1. A coaxial connector device for electrically connecting a coaxial cable connector and a printed circuit board, the coaxial connector device comprising a main connector and a board connector to be mounted on a printed circuit board,
the main connector including:
a conductive main connector body having a first fitting part for a coaxial cable connector at one end, and a second fitting part at the other end;
a center contact positioned, inside the main connector body, on a side with the first fitting part; and
a card edge substrate positioned, inside the main connector body, on a side with the second fitting part, the card edge substrate being electrically connected to the center contact,
the board connector including:
a board connector body in which a slot is formed, the board connector body being provided with a plurality of contacts in the slot;
an outer conductor contact provided in the board connector body; and
a conductive plate member positioned on a side opposite to the side where the slot is formed in the board connector body such that the conductive plate member is not in contact with the plurality of contacts in the slot,
wherein, when the second fitting part of the main connector body is fitted to the board connector, an end portion of the card edge substrate is coupled to the slot in the board connector body, a plurality of substrate contacts included in the card edge substrate electrically contact the plurality of contacts of the board connector body, and the second fitting part of the main connector body electrically contacts the outer conductor contact.

2. The coaxial connector device according to claim. 1, wherein, when the board connector is mounted on the printed circuit board, the conductive plate member is at ground potential.

3. The coaxial connector device according to claim 1, wherein the conductive plate member is formed integrally with and as a part of the outer conductor contact.

4. The coaxial connector device according to claim 1, wherein the second fitting part has an inner face which, when the second fitting part is fitted to the board connector, contacts at least the outer conductor contact.

5. The coaxial connector device according to claim 4, wherein the inner face of the second fitting part of the main connector body is cylindrical or semi-cylindrical and the outer conductor contact of the board connector includes a spring member provided outside the board connector body.

6. The coaxial connector device according to claim 3, wherein each of the plurality of contacts of the board connector and the outer conductor contact have a connection terminal extending from a bottom part or a bottom face of the board connector body in the width direction of the board connector.

7. The coaxial connector device according to claim 6, wherein the connection terminals of the board connector are configured such that, when the board connector is mounted on a surface of a printed circuit board, the connection terminals are connected to respective wirings on the printed circuit board.

8. The coaxial connector device according to claim 1, wherein the card edge substrate of the main connector includes at least one active circuit.

9. The coaxial connector device according to claim 8, wherein the active circuit includes at least a first matching circuit, a second matching circuit to be connected to the center contact, and a buffer circuit provided between the first matching circuit and the second matching circuit.

10. The coaxial connector device according to claim 1, wherein the slot of the board connector is formed such that, when the board connector is mounted on a printed circuit board, the slot is oriented at a predetermined angle with respect to one face of the printed circuit board or in parallel with the one face of the printed circuit board.
